(19) United States
(12) Patent Application Publication
(10) Pub. No.: US 2005/0063333 A1
(43) Pub. Date: Mar. 24, 2005

(54) System and method for accessing network and data services

(75) Inventors: David Patron, Cedar Park, TX (US); Michael F. Grannan, Austin, TX (US); Bach Hoang, Austin, TX (US); Sreenivasa Rao Gorti, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/669,122

(22) Filed: Sep. 23, 2003

(51) Int. Cl. H04Q 7/00; H04L 12/28

(52) U.S. Cl. 370/329; 370/400

(57) ABSTRACT

A system and method for accessing network and data services are disclosed. In one embodiment of a system incorporating teachings of the present disclosure, a wireless networking hub may be communicatively coupled to a global communications network. A remote authentication engine may be communicatively coupled to the wireless networking hub. The authentication engine may be capable of receiving an initial set of credentials from a user seeking access to network transport services and data services. In preferred embodiments, the system may include an authorization engine capable of granting access to both the network transport services and the data services in response to authorization of the first set of credentials.

### BACKGROUND OF THE DISCLOSURE

In recent years, wireless local area networks have become more pervasive. Some of these networks have an ad-hoc or peer-to-peer schema, while others employ a hub-based schema. Ad-hoc wireless networks usually consist of several computing devices, each equipped with a wireless transceiver. The individual devices communicate directly with one another wirelessly. Ad-hoc networks may be employed to share files or printers. In many circumstance, the computing devices of an ad-hoc wireless network will not be able to access wired local area network (LAN) resources unless one of the devices acts as a bridge to the wired LAN.

Wireless networks designed to utilize a hub-based schema often have an access point acting as the hub and providing a central point of connectivity for the wireless computing devices that make up the wireless LAN. In addition to acting as a central point of connectivity for the network, the hub may connect or “bridge” the wireless LAN to a wired network, allowing “connected” wireless computing devices to access LAN resources as well as broader network resources.

One popular incarnation of wireless networking technology involves the wireless-Ethernet standard known as IEEE 802.11. Of the various 802.11 compliant solutions, Wi-Fi may be the most popular. Wi-Fi (which may be implemented as “802.11b”, “802.11 g” and/or “802.11a”) has emerged as a dominant standard for wireless LANs (WLANs) and has enjoyed a substantial increase in the number of individuals and businesses “turning on” Wi-Fi networks.

In fact, many businesses are beginning to offer wireless networking services to their employees and their customers. In most cases, the business pays for a broadband wired backhaul service or other network transport service that connects the business to a global communication network like the Internet and, then, the business makes that connection available to employees and customers across a wireless LAN.

### BRIEF DESCRIPTION OF THE DRAWINGS

The present invention is pointed out with particularity in the appended claims. However, features are described in the following detailed description in conjunction with the accompanying drawings in which:

FIG. 1 shows a block diagram of a network and data access system incorporating teachings of the present disclosure. The system of FIG. 1 depicts a private network operator with multiple wireless LAN hubs;

FIG. 2 depicts a simplified flow chart for a network and data services access method that incorporates teachings of the present disclosure; and

FIG. 3 depicts a communication system that incorporates teachings of the present disclosure. The system of FIG. 3 shows multiple web-based data services, multiple private network operators, and a federated access system.

### DETAILED DESCRIPTION OF THE DRAWINGS

Wireless services often authenticate users based on the handset or the device associated with a given user. The wireless service provider usually recognizes and authenticates the associated device and, as such, the user, while the device is seeking access to the service provider's network. In many cases, the operator is both the identity provider and the service provider.

In the wireline Internet model, data service providers and network transport service providers may be different entities. In many cases, the step of network authentication may be implicit. An authenticated network connection may exist or be launched “behind the scenes” as a result of launching a web browser or other application. In practice, the user may only see the step of authenticating to individual data service providers.

The Wi-Fi service model may be a mix of the two. The user may authenticate with the network either implicitly (device-based) or explicitly (user-name/password). Because data services may be offered by any provider (following the general Internet model), there may be an additional need to authenticate with each of these service providers. Among other things, teachings in the present disclosure describe a technique for leveraging the fact that a user has already authenticated to the network and using this to also authenticate to services. In order to facilitate authentication to a network transport service and a wide range of service providers, an identity provider may vouch for the user's identity.

Identity, which may include related attributes like profile, location and presence, may facilitate enablement of a range of Wi-Fi services, like customized coupons as you enter a mall, directions to nearby restaurants, etc. There may be several ways to architect a system incorporating teachings of the present disclosure. In one embodiment, hotspot authentication by a local access controller may be passed along to other providers, effectively treating the access controller as a federated service provider.

In other embodiments, user authentication to the network may occur in multiple ways. A user may explicitly enter username and password to authenticate to the network. The process may use the MAC address associated with the device. A secure digital certificate stored on the device may be used. In addition, each of the device-based authentication schemes may further be augmented by username/password or biometrics; and/or the access controller may support the Radius authentication protocol. In this case, the access controller may pass the credentials to a Radius Proxy, which could communicate with an identity server using other protocols (like SAML, XML, etc). As mentioned above, the network authentication may be federated with the identity provider.

In one embodiment, network authentication may offer a basic level of service authentication, while access to services that require higher security would make the identity provider prompt the user for additional credentials. In some embodiments, the access controller and the identity provider may be the same entity. In this case, when the user is authenticated to the network, the user is simultaneously authenticated to the services registered with the identity provider. The teachings of this disclosure are described below with reference to specific embodiments.

As mentioned above, many businesses are beginning to offer wireless networking services to their employees and their customers. In a typical situation, the business pays for a broadband backhaul service or other network transport service that communicatively connects the business to a global communication network like the Internet. The business may then make the connection available to employees and customers using a wireless LAN. In some circumstances, the business may charge a fee for utilizing the business' transport service.

The fee may be prepaid, post-paid, and/or pay-per-use. The fee may based on some time-based metric like hourly, daily, or monthly. The fee may also be based on another unit of measure all together like bits across the network. In some prepayment embodiments, a user may enter a credit or debit card number. The user may also purchase a prepaid access card and provide information associated with that card to an entity providing transport and/or data services.

Whatever the basis for billing, the business will likely need to know who is accessing its network and utilizing its transport service. The business may want to track how long the user has been on-line, how much data the user is pushing, how to bill the user, and how the user plans to pay. Much of this information is easier to gather if the user is registered and required to “log-in” to the transport service.

Occasionally, the business will provide access to the transport service for free. In situations where the transport is offered for free, the business may still want and/or need to know who is on the business' network and who is accessing a larger network like the Internet through the business' wireless LAN. As a result, a business providing free access may still ask a user of the wireless LAN to register or to log in to let the business owner know that he or she is “connected” to the business' network and potentially through the business network to a broader network.

Whatever the motivation, businesses that make their transport services available to customers and employees via a wireless or wired LAN may want the individuals using the service to log-in with credentials that uniquely identify the individual. Unfortunately, this seemingly reasonable desire on the part of business owners may create yet another user name and password combination to be remembered. Moreover, once logged in to the transport service, a user may still need to log in to each data service to which the user belongs.

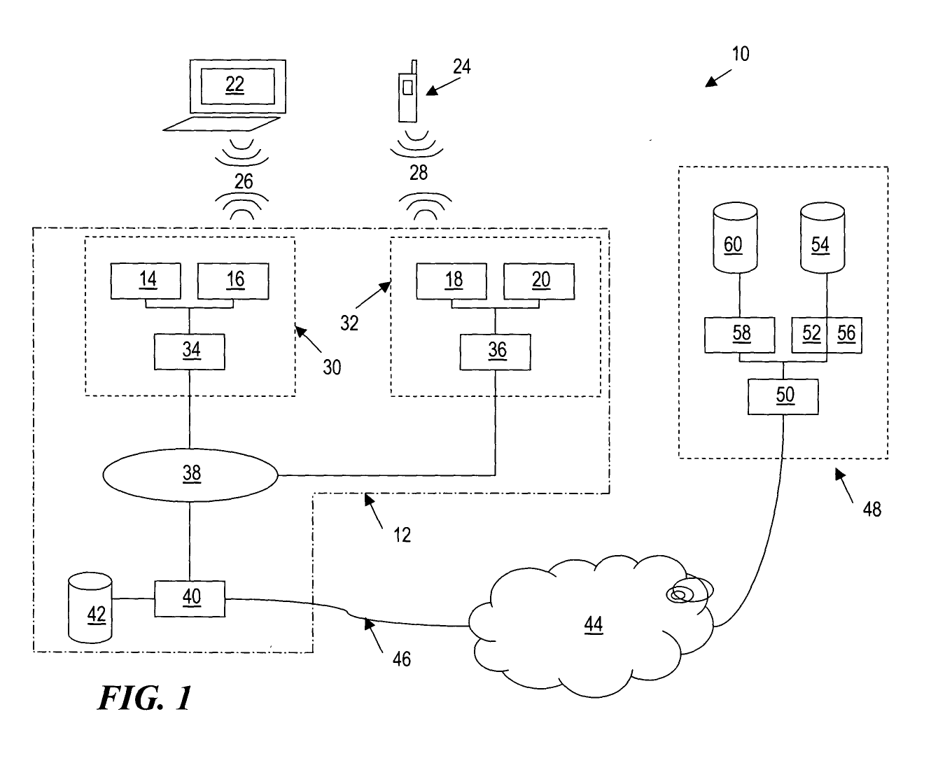

If the user has a web-based electronic mail account, the user may be prompted to enter another set of credentials. If the user has an on-line brokerage account, the user may be prompted to enter yet another set of credentials. As mentioned above in the brief description of the drawings, FIG. 1 shows a block diagram of a network and data access system 10 that incorporates teachings of the present disclosure. System 10 may help, among other things, alleviate some of the multi-step log-in difficulties discussed above.

As shown in FIG. 1, system 10 depicts a private network 12 with multiple wireless LAN hubs 14, 16, 18, and 20. Though the LAN hubs are depicted as wireless access points capable of wirelessly linking to computing devices, in some embodiments, a network operator may elect to connect hubs and computing devices with wires. In the embodiment of FIG. 1, two wireless computing devices (laptop 22 and wireless phone 24) have short-range or local area wireless transceivers that serve to connect the devices to LAN hubs 16 and 18, respectively. Laptop 22 is “connected” to LAN hub 16 across wireless link 26, and wireless phone 24 is “connected” to LAN hub 18 across wireless link 28.

Laptop 22 and wireless phone 24 may each include several electronic components and computing devices. Both laptop 22 and phone 24 may also include a computer-readable medium having computer-readable data to initiate a query to find an 802.11 network, to initiate presentation of information that indicates at least one found network, to request connection to the at least one found network, to receive an input requesting retrieval of information associated with a network data service, to receive a request for user credentials, to initiate communication of input user credentials, and to maintain an authorization token indicating a right to access both the found network and the network data service.

Wireless links 26 and 28 may be the same type or different types of wireless links. The link type may depend on the electronic components associated with the given wireless devices and wireless LAN hubs. The wireless computing device and/or wireless hub (Wireless Enabled Devices) may include any of several different components. For example, a Wireless Enabled Device may have a wireless wide area transceiver, which may be part of a multi-device platform for communicating data using radio frequency (RF) technology across a large geographic area. This platform may be a GPRS, EDGE, or 3GSM platform, for example, and may include multiple integrated circuit (IC) devices or a single IC device.

A Wireless Enabled Device may also have a wireless local area transceiver as shown in FIG. 1, which may communicate using spread-spectrum radio waves in a 2.4 GHz range, 5 GHz range, or other suitable range. The wireless local area transceiver may be part of a multi-device or single device platform and may facilitate communication of data using low-power RF technology across a small geographic area. For example, if the wireless local area transceiver includes a Bluetooth transceiver, the transceiver may have a communication range with an approximate radius of twenty-five to one hundred feet. If the wireless local area transceiver includes an 802.11(x) transceiver, such as an 802.11(a)(b) or (g), the transceiver may have a communication range with an approximate radius of one hundred fifty to one thousand feet.

As shown in FIG. 1, LAN hubs 14 and 16 make up part of wireless site 30, and LAN hubs 18 and 20 make up part of wireless site 32, which may be geographically removed or remote from wireless site 30. In an 802.11(x) embodiment, wireless site 30 may be referred to as a hotspot. Wireless sites 30 and 32 may also include respective access controllers 34 and 36. Though shown within the site, access controllers may be located in other locations or removed all together.

Wireless sites 30 and 32 may be communicatively coupled to a network bridge 38 capable of connecting the sites to a private network management server 40. The sites may be connected through an access controller, as depicted, through some other intermediary devices, or directly. Management server 40 may be capable of receiving and responding to requests for private network information, which may be located in local data store 42. Management server 40 may also act as a gateway to a broader network. As shown, management server 40 is communicatively coupled to Internet 44 via link 46.

In practice, the information communicated across link 46 may be compressed and/or encrypted prior to communication. The communication may be via a circuit-switched network like most wireline telephony networks, a frame-based network like Fibre Channel, or a packet-switched network that may communicate using TCP/IP packets like Internet 44. The physical medium making up at least a portion of link 46 may be coaxial cable, fiber, twisted pair, an air interface, other, or combination thereof. In some embodiments, link 46 may be a broadband connection facilitated by an xDSL modem, a cable modem, another 802.11x device, some other broadband wireless linking device, or combination thereof.

In a preferred embodiment of system 10, a user may seek to log into Internet 44 and data services associated therewith. The user may be operating laptop 22 and connect to wireless LAN hub 16 via link 26. The user may then use a browser like Netscape or Internet Explorer to request access to a web-based data service. In some embodiments, this request will be identified and the user will be directed to a unified access operator 48. Operator 48 may be a company or service that manages subscriber credentials for a federation of private network operators. Operator 48 may provide authentication and access services to the LAN operators.

Though operator 48 is depicted as a remote authentication service bureau for a third party private network operator in FIG. 1, operator 48 may, in some embodiments, operate its own collection of wireless sites, act as an authentication service bureau for a plurality of third party network operators, provide transport services, provide web-based data services, or engage in any other activity.

Operator 48 may have a gateway 50 that receives an initial set of credentials from the requesting user attempting to access transport and data services from laptop 22. Gateway 50 may communicate with authentication engine 52, which may be capable of comparing the initial set of credentials against information maintained in data store 54. In some embodiments, gateway 50 may re-direct the requesting user to an identity provider, which may be a third party. The identity provider may authenticate then authenticate the requesting user.

If the credentials are verified, authentication engine 52 or a component of a third party identity provider may output an “accepted” signal, which may be directed to an authorization engine like authorization engine 56. In response to the accepted signal, authorization engine 56 may grant laptop 22 and its user access to both the transport services offered by the operator of private network 12 and the data services of federated web-based data service providers.

In some embodiments, operator 48 may provide data services like web-based electronic mail, voice mail accounts, a unified messaging service, financial account services, customized home page services with user-selected content presented in a user-defined format, some other user-specific data service, and/or combinations thereof. To offer these data services, operator 48 may employ a data service application server 58, which may have a data store 60. In preferred embodiments, the access granted by authorization engine 56 will allow the user of laptop 22 to bypass any additional log in procedures that may have been otherwise necessary to access the data services of operator 48 or the data services of other federated data service providers.

Embodiments supporting simplified access to federated data service providers may make use of some security standards like WS-Security for high-level security services, XACML for access control, XCBF for describing biometrics data, SPML for exchanging provisioning information, and XrML for rights management. As deployed, system 10 may use at least one version of the Security Assertion Markup Language (SAML). SAML is an authentication language with an Extensible Markup Language (XML) based framework. SAML may help secure transmitted communications over local communication networks and broad communication networks like the Internet.

SAML may also be used to define federation exchange mechanisms that facilitate the exchange of authentication, authorization, and nonrepudiation information. The Organization for the Advancement of Structured Information Standards (OASIS) recently ratified Version 1.0 of SAML, which is incorporated herein by reference. In preferred embodiments, deployed systems incorporating teachings of the present disclosure may also include additional security enhancements, such as opt-in account linking, multiple levels of log in, simple session management, and global log-out capabilities.

For example, authorization engine 56 may require relatively low security credentials to access a unified mailbox and higher security credentials to access financial-based data services. Credentials may take several forms. Credentials may include, for example, device-based identifiers, machine readable identification information, username/password combinations, and/or biometric information like finger prints or retinal scans.

In operation of system 10, a component of operator 48's network may be a server made up of a microprocessor, a personal computer, a computer, some other computing device, or collection thereof. The server or servers may be operating as one or more of the above described engines in addition to other engines. The server or servers may also include a computer-readable medium having computer-readable data to access maintained credentials of a plurality of users, to direct an authentication engine to compare input credentials against maintained credentials, to signal an authorization engine of accepted input credentials, and to initiate communication authorizing access to both a network transport service and a network data service.

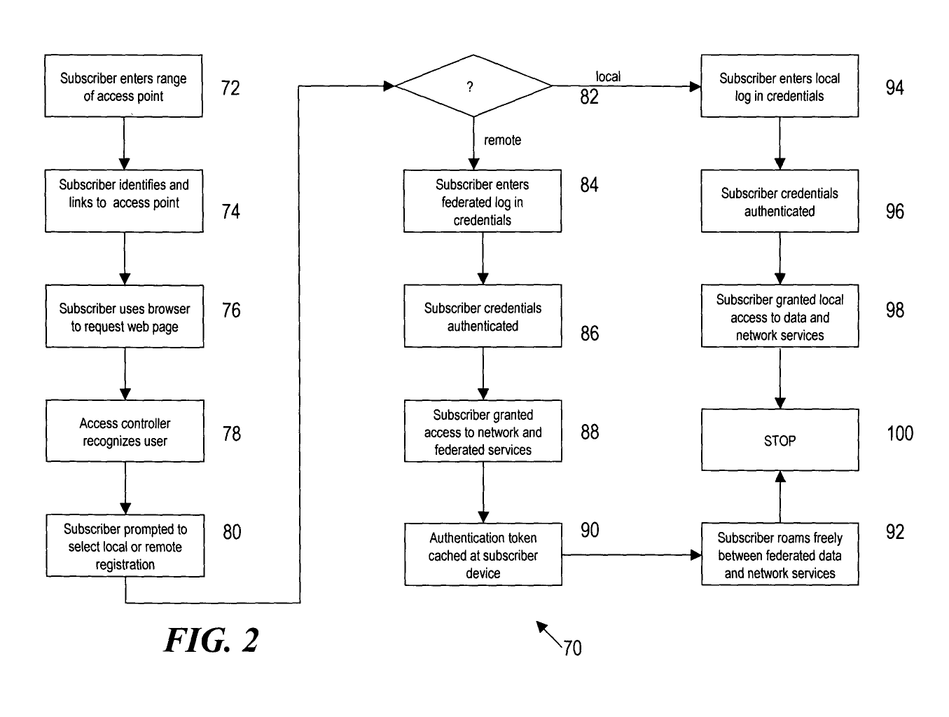

An understanding of system 10's operation may be more readily understood by reference to FIG. 2. As mentioned above, FIG. 2 depicts a simplified flow chart for a network and data services access method 70 that incorporates teachings of the present disclosure. Method 70 imagines an embodiment similar to system 10 of FIG. 1 having multiple wireless access points. Method 70 may also be applied to wired LAN applications, and system 10 could make use of a method other than method 70.

As depicted in FIG. 2, method 70 begins at step 72 when a subscriber comes into range of a wireless access point. The user may search for available wireless networks using a sniffer application that identifies available access points. In preferred embodiments, the sniffer application may present the user with a displayed pick list of available LAN hubs and present an icon in connection with those hubs associated with a federated network.

The user may find a federated hub and link to it at step 74. At step 76, the user may use a browser to request some web-based content. For example, the user could type in a URL of a unified messaging home page. The user and/or the user's request may be recognized at step 78 by an access controller, which may be a software engine operating at a computing platform local to or closely connected to the access point. The software engine may also be operating at a remote location like gateway 50 of FIG. 1. At step 78, an access controller may provide a page to the user. The page may include information related to the location of the access point.

At step 80, a system incorporating method 70 may ask the subscriber if the subscriber desires broad or local network access. If the subscriber indicates at step 82 a desire for broad network access, method 70 may move to step 84 and the subscriber may be prompted to enter a first set of credentials. For example, the user may be prompted to enter a user name and password combination. If the subscriber credentials are authenticated at step 86, the subscriber may be granted access to both federated data services and federated network transport services at step 88.

The federated transport services may be embodied by the wireless LAN access point the subscriber initially connected to at step 74 as well as the transport services connecting that access point to a broad global communications network like the Internet. The federated transport services may also include wireless and wired LANs operated by the same party operating the wireless LAN to which the subscriber is currently connected. The federated transport services could also include wireless and wired LANs operated by federated third parties or any other appropriate communication transport service.

In one embodiment, a system executing method 70 may lease a token to the subscriber at step 90, and the token may be cached on the computing device being used by the subscriber. As such, when the subscriber roams at step 92 to another federated transport service or browses to another federated web-based data service, the subscriber will be “recognized” and will not be asked to go through another credential exchanging log in.

In some embodiments, the subscriber may have linked several computing devices to his or her account. In such an embodiment, a token may be leased to each of the subscriber's linked devices—allowing the subscriber to connect with different devices at the same or different times. A system executing method 70 may limit this log in free connection period to some defined metric. The defined metric may be the length of time or the number of connections for which the token or tokens are leased.

If at step 82, the subscriber elects local log in, method 70 may move to step 94 where the subscriber keys in local log in information. Once the credentials are authenticated at step 96, the subscriber may be granted access at step 98 to locally stored information or some limited walled-garden list of information. Whether broad or local network access is requested, method 70 may eventually progress to a stop at step 100.

An operator may want to provide both a broad and local network option to subscribers. In some cases, access to the broad network may be offered as a for-pay option and access to the local network may be offered for free or at a reduced rate. The local network may include location-specific information like a map of the area or a menu for a nearby restaurant.

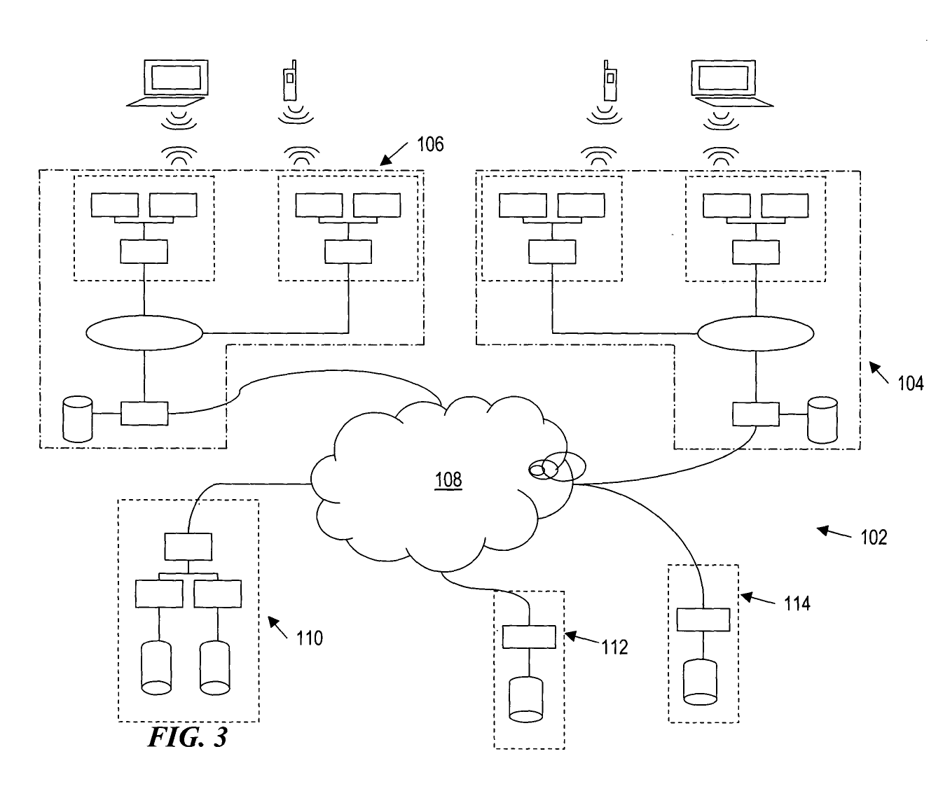

As mentioned above, FIG. 3 depicts a communication system 102 that incorporates teachings of the present disclosure. System 102 depicts two private networks 104 and 106 connected to a global communication network like Internet 108, a unified access operator 110, and two web based data services 112 and 114. As depicted, private networks 104 and 106, access operator 110, and data services 112 and 114 are part of a federated network and share subscriber identity information, log in credentials, and log in state with one another across Internet 108.

In a preferred embodiment of system 102, a subscriber may register with access operator 110 as a federated subscriber. The federated subscriber may have identified a group of federated third party data service providers with whom the subscriber will “allow” access operator 110 to share credentials. If data services 112 and 114 are included in the subscriber's linking list, the subscriber may be able to log in once via access operator 110 and roam unencumbered between federated data services 112 and 114 and data services provided by access operator 110.

Similarly, if the subscriber selects a federated transport service provider, the act of logging in to the transport service may automatically log the user in to federated data services—effectively removing the obligation to log in again and again as the subscriber moves from third party site to third party site, without regard for whether the third party sites has a transport-focus or a web-based data-focus.

Though the process described above indicates that a user may log in via the access operator, in other embodiments, the log in may occur at another federated site. The process of sharing credentials and granting access to both transport and data services may be effectuated and/or initiated by entities other than access operator 110. As depicted in system 102, access operator 110 may act as a clearing house or a service bureau for other entities, but other techniques may be employed without departing from the teachings of the present disclosure.

It will be apparent to those skilled in the art that the disclosed embodiments may be modified in numerous ways and may assume many embodiments other than the particular forms specifically set out and described herein.

Accordingly, the above disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A network access system comprising:
a first network access hub communicatively coupled to a global communications network;
a second network access hub communicatively coupled to the global communications network;
an authentication engine communicatively coupled to the first network access hub and the second network access hub, the authentication engine operable to receive an initial set of credentials from a requesting user via the global communications network; and
an authorization engine operable to grant access to both transport services and data services in response to authorization of the first set of credentials.

2. The system of claim 1 further comprising a short-range wireless transceiver associated with the first network access hub.

3. The system of claim 2, wherein the transport services comprise wireless communication via a wireless local area network technology link.

4. The system of claim 3, wherein the data services comprise a service that provides personalized information based on an identity of the requesting user.

5. The system of claim 4, wherein a first data service is provided by a first service provider, the data services further comprising another data service provided by a different service provider.

6. The system of claim 5, further comprising a federation engine operable to maintain information that indicates members of a service provider federation, the service provider federation comprising the first service provider and the different service provider.

7. A network access method comprising:
receiving a first set of credentials; and
authorizing access to a network data service and a network transport service in response to authenticating the first set of credentials.

8. The method of claim 7, further comprising:
receiving a request for access from an electronic device;
prompting the electronic device to send the first set of credentials;
authenticating the first set of credentials; and
communicating an authentication token to the electronic device.

9. The method of claim 8, further comprising:
requesting that the electronic device cache the authentication token;
receiving a subsequent request for access from the electronic device;
recognizing an existence of the authentication token at the electronic device; and
authorizing access in response to the subsequent request without further authentication.

10. The method of claim 7, further comprising;
receiving a request from an electronic device seeking access to a first data service via a first transport service;
prompting the electronic device to send the first set of credentials;
authenticating the first set of credentials;
receiving a request from a second electronic device seeking access to a second data service via a second transport service;
prompting the second electronic device to send a set of credentials; and
authenticating the set of credentials.

11. A computer-readable medium having computer-readable data to access maintained credentials of a plurality of users, to direct an authentication engine to compare input credentials against maintained credentials, to signal an authorization engine of accepted input credentials, and to initiate communication authorizing access to both a network transport service and a network data service.

12. A computer-readable medium having computer-readable data to initiate a query to find an 802.11 network, to initiate presentation of information that indicates at least one found network, to request connection to the at least one found network, to receive an input requesting retrieval of information associated with a network data service, to receive a request for user credentials, to initiate communication of input user credentials, and to maintain an authorization token indicating a right to access both the found network and the network data service.

13. A network access system comprising:
a plurality of hotspots communicatively coupled to a broad communications network;
an authorization engine communicatively coupled to the broad communications network and operable to issue an authentication token to an electronic device communicatively coupled to at least one of the plurality of hotspots; and
the authentication token operable as a valid indicator of access rights to both transport services and data services.

14. The system of claim 13 further comprising the electronic device having a cache operable to store the authentication token.

15. The system of claim 13, wherein authentication token is a valid indicator of access rights to both transport services and data services at a second one of the plurality of hotspots.

16. The system of claim 13, further comprising:
an authentication engine communicatively coupled to the broad communications network and operable to receive an initial set of credentials from a requesting user and to compare the initial set of credentials against a maintained set of credentials;
a valid signal indicating that the requesting user is a valid user; and
a federation engine operable to initiate a sharing of information associated with the valid user with a first federated data service provider.

17. The system of claim 13, further comprising:
an authentication engine communicatively coupled to the broad communications network and operable to output a valid signal indicating that a user requesting access is a valid user and entitled to transport and data service access;
a federation engine operable to initiate a sharing of at least a portion of a valid user information file with a first federated data service provider; and
the valid user information operable to facilitate access to a federated data service without additional sign on operations by the user requesting access.

18. The system of claim 13, wherein the data service comprises a unified messaging mailbox.

19. The system of claim 18, wherein the transport service comprises access to the broad communication network via the at least one of the plurality of hotspots.

20. The system of claim 19, further comprising:
an authentication engine communicatively coupled to the broad communications network and operable to output a valid signal indicating that a user requesting access is a valid user and entitled to transport and data service access;
a federation engine operable to initiate a sharing of at least a portion of a valid user information file with a first federated data service provider; and
the valid user information operable to facilitate access to a federated data service without additional sign on operations by the user requesting access.
